(19) United States
(12) Patent Application Publication
(10) Pub. No.: US 2025/0193791 A1
(43) Pub. Date: Jun. 12, 2025

(54) TERMINAL DEVICE AND COMMUNICATION CONTROL METHOD

(71) Applicant: HONDA MOTOR CO., LTD., Tokyo (JP)

(72) Inventors: Takafumi SAITO, Tokyo (JP); Kenji NAKANISHI, Tokyo (JP)

(73) Assignee: HONDA MOTOR CO., LTD., Tokyo (JP)

(21) Appl. No.: 19/062,769

(22) Filed: Feb. 25, 2025

Related U.S. Application Data
(63) Continuation of application No. PCT/JP2022/033741, filed on Sep. 8, 2022.

(51) Int. Cl. H04W 52/02

(52) U.S. Cl. CPC H04W 52/0219

(57) ABSTRACT

A terminal device includes a control unit configured to receive, via a sidelink, an urgent message transmitted by a terminal device located in a first geographical area, by using a first transmission field in a transmission frame section corresponding to an ON section in a DRX cycle. The control unit is further configured to transmit, via the sidelink, the received urgent message so as to relay that urgent message to a terminal device located in a second geographical area adjacent to the first geographical area, by using a second transmission field in the transmission frame section corresponding to the ON section in an identical DRX cycle to the first transmission field.

### CROSS-REFERENCE TO RELATED APPLICATION(S)

This application is a continuation of International Patent Application No. PCT/JP2022/033741 filed on Sep. 8, 2022, the entire disclosures of which is incorporated herein by reference.

### BACKGROUND OF THE INVENTION

### Field of the Invention

The present invention relates to a terminal device and a communication control method.

### Description of the Related Art

In Third Generation Partnership Project (3GPP (registered trademark)), a technique for two user equipments (UEs) in a cellular communications system to perform Vehicle-to-Everything (V2X) communication on a sidelink is standardized. For example, the UE for performing sidelink communication establishes a radio link called PC5 interface with the UE of a communication destination, and performs V2X communication on a communication resource scheduled by a radio access network (RAN) or a communication resource autonomously selected from a resource pool allocated beforehand (3GPP TS38.300 v16.8.0, Dec. 23, 2021).

US-2020-0312142 discloses a technique in which a terminal device that is capable of performing V2X communication and that is mounted on a vehicle evaluates safety on a road in real time, and when determining presence of some kind of threat, the device gives an alarm to a user of the vehicle or another user.

In 3GPP TR23.776 v17.0.0, Mar. 31, 2021, in a scenario of V2X communication in which a message about the safety on a road is transmitted and received, when a discontinuous reception (DRX) operation for reducing power consumption on a terminal device is performed, the timing of an ON section for performing a reception operation being synchronized for every geographical area is studied in order to enable transmission and reception of a message.

In a scenario in which ON sections in the DRX cycle are synchronized between terminal devices in the same geographical area, when a terminal device located in an overlapping area of a plurality of geographical areas receives a message of high urgency (for example, a message informing of the presence of a threat about the safety on a road), it can be assumed that the terminal device relays the message. Accordingly, it becomes possible to share the message of high urgency with another terminal device within a wider geographical area. However, after receiving the message and waiting for the next DRX cycle, if relay transmission of the message is performed, this may lead to a delay in notification of the message.

### SUMMARY OF THE INVENTION

The present disclosure provides a technique for, in a terminal device that performs a DRX operation, relaying a message of high urgency received in a first geographical area to an adjacent second geographical area more promptly.

According to the present disclosure, there is provided a terminal device comprising: a radio communication unit capable of operating in a discontinuous reception (DRX) mode, and configured to perform radio communication via a radio link between the terminal device and a base station and radio communication via a sidelink between the terminal device and another terminal device; and a control unit configured to control the radio communication by the radio communication unit, wherein the control unit is configured to: receive, via the sidelink, an urgent message transmitted by a terminal device located in a first geographical area, by using a first transmission field in a transmission frame section corresponding to an ON section in a DRX cycle; and transmit, via the sidelink, the received urgent message so as to relay that urgent message to a terminal device located in a second geographical area adjacent to the first geographical area, by using a second transmission field in the transmission frame section corresponding to the ON section in an identical DRX cycle to the first transmission field.

Further features of the present invention will become apparent from the following description of exemplary embodiments (with reference to the attached drawings).

### BRIEF DESCRIPTION OF THE DRAWINGS

FIG. 1 is a copy of FIG. 16.9.1-1 in 3GPP TS38.300 v16.8.0;

FIG. 2 is a copy of FIG. 6.2-2 in 3GPP TS23.286 v17.3.0;

FIG. 3 is a schematic diagram illustrating a configuration example of a V2X communication system according to one embodiment;

FIG. 4 is a block diagram illustrating a configuration example of a server apparatus according to one embodiment;

FIG. 5 is an explanatory diagram for describing an example of definitions of geographical areas according to one embodiment;

FIG. 6 is a block diagram illustrating a configuration example of a UE according to one embodiment;

FIG. 7 is a block diagram illustrating a configuration example of a base station according to one embodiment;

FIG. 8 is an explanatory diagram for describing urgent message transmission processing by the UE according to one embodiment;

FIG. 9 is a flowchart illustrating an example of a processing procedure by the UE according to one embodiment; and

FIG. 10 is a sequence diagram illustrating an example of a flow of processing in the V2X communication system according to one embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### Basic System Architecture for V2X Service

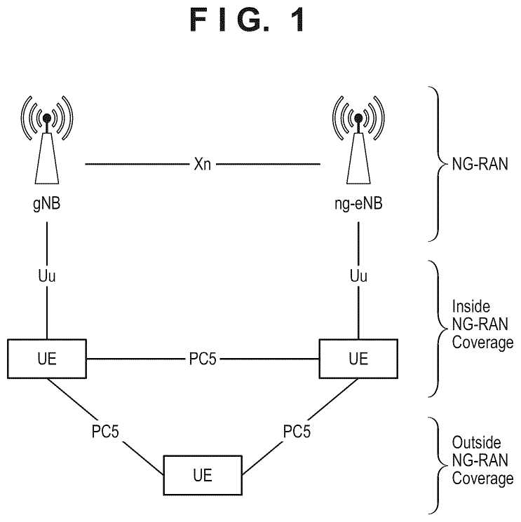

FIG. 1 is a copy of FIG. 16.9.1-1 of 3GPP TS38.300 v16.8.0, and illustrates an example of an NG-RAN architecture for a 5G system. gNB is a 5G base station connected to a 5G core network (not illustrated). ng-eNB is a 4G base station connected to a 5G core network. gNB and ng-eNB are connected to each other through an Xn interface. A user equipment (UE) is a terminal device to be serviced by the gNB or the ng-eNB. A radio link for transmitting and receiving user data between the UE and the gNB or the ng-eNB will be referred to as a Uu interface. A PC5 interface is a communication link established between two UEs. Such a direct communication link between UEs that does not pass through a base station will also be referred to as a sidelink. Next generation (NG)-radio access network (RAN) supports such a PC5 interface. The PC5 interface can be identified by a pair of a layer-2 ID (Source Layer-2 ID) allocated to a UE on a transmission side and a layer-2 ID (Destination Layer-2 ID) allocated to a UE on a reception side. The resource used for communication is scheduled by the base station (scheduled resource allocation), or is autonomously selected by the UE from a preset resource pool (autonomous resource selection). In the 5G system, such a PC5 interface can be utilized for the V2X service.

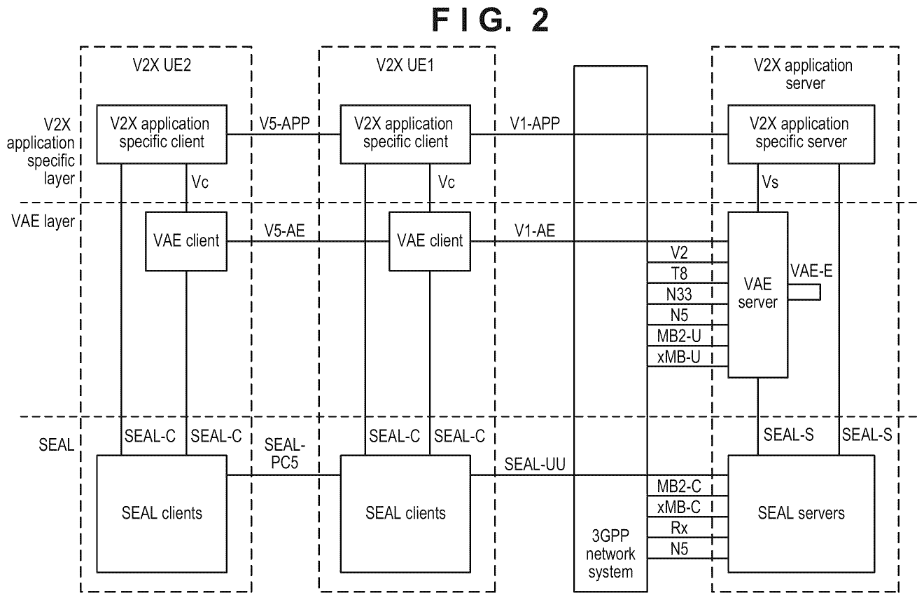

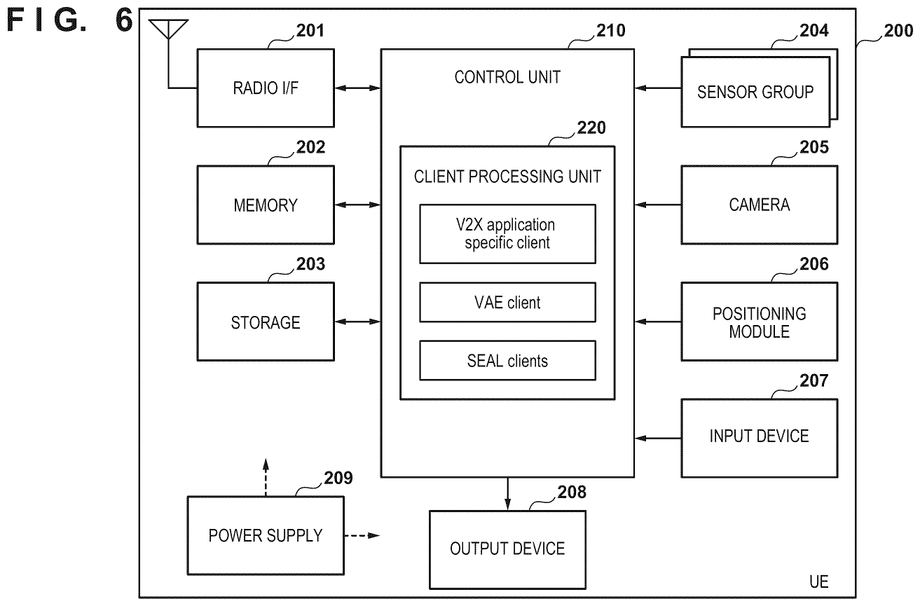

FIG. 2 is a copy of FIG. 6.2-2 of 3GPP TS23.286 v17.3.0, and illustrates a hierarchical functional model of a V2X application. In the functional model of FIG. 2, the UE operates as a client (V2X UE) of a V2X application. On the other hand, a server of the V2X application is typically deployed on an Internet Protocol (IP) network, and communicates with one or more V2X UEs via a 3GPP network system including a RAN and a core network. The V2X UE located inside the coverage of NG-RAN (V2X UE1 in FIG. 2) is capable of communicating via a sidelink with the V2X UE located outside the coverage (V2X UE2 in FIG. 2).

The functional model of FIG. 2 has a hierarchical structure including a V2X application specific layer, a V2X application enabler (VAE) layer, and a service enabler architecture layer (SEAL) sequentially from the top in the drawing.

The SEAL is a layer that provides basic services common to various applications including V2X and other types of applications. Services related to V2X applications provided in the SEAL include, for example, location management, group management, setting management, identity management, key management, and network resource management. The V2X UE includes a SEAL client, and the V2X application server includes a SEAL server. SEAL-PC5 is an interface between V2X UEs in the SEAL. SEAL-UU is an interface between the V2X UE and the V2X application server in the SEAL. Details of the functions of the SEAL client and SEAL server are described in 3GPP TS23.434 v17.5.0.

The VAE layer is a layer that supports the V2X application specific layer, by interpreting a service provided by the SEAL to be used for a V2X application. The V2X UE includes a VAE client, and the V2X application server includes a VAE server. Examples of the functions provided by the VAE client may include registration of the VAE client in the VAE server for reception of V2X messages, provision of application-level location information for the VAE server, reception of communication setting information from the VAE server, and support for dynamic group management. Examples of the functions provided by the VAE server may include acceptance of registration of a VAE client, tracking the location of the V2X UE at an application level, provision of communication setting information, and support for delivery of V2X messages. V5-AE is an interface between V2X UEs in the VAE layer. V1-AE is an interface between the V2X UE and the V2X application server in the VAE layer.

The V2X application specific layer is a layer that provides functionality specific to an individual V2X application, while receiving the support from the VAE layer. The V2X UE includes a V2X application specific client, and the V2X application server includes a V2X application specific server. V5-APP is an interface between the V2X UEs in the V2X application specific layer. V1-APP is an interface between the V2X UE and the V2X application server in the V2X application specific layer.

The functions of the V2X UE and the V2X application server that can have such a hierarchical structure according to embodiments of the technique of the present disclosure will be described later in detail.

As understood from FIG. 2, V2X communication is treated as end-to-end communication between the V2X UE and the V2X application server at an application level, and contents of the V2X communication are transparent to a base station and any other network node on the way of such a communication path.

Section 7 of 3GPP TS23.286 v17.3.0 describes various deployment models for the V2X application specific server and the VAE server. The V2X application specific server and the VAE server may be co-located on a physically single device, or may be respectively located on separate devices. Each of these servers may belong to any of a domain of a V2X service provider and a domain of a network operator.

### Overview of V2X Communication System

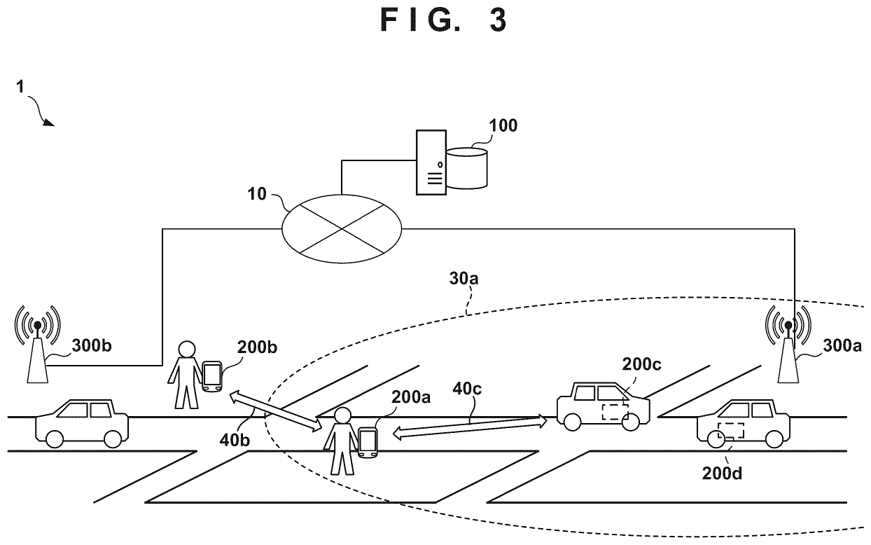

FIG. 3 is a schematic diagram illustrating a configuration example of a V2X communication system 1 according to one embodiment. Referring to FIG. 3, the V2X communication system 1 includes a server apparatus 100, UEs 200a, 200b, 200c, and 200d, and base stations 300a and 300b.

Note that in the following description, in a case where it is not necessary to distinguish among the UEs 200a, 200b, 200c, and 200d from one another, they will be collectively referred to as the UE 200 by omitting an alphabetical character at the end of a reference numeral. The same reasoning applies to the base stations 300a and 300b (the base station 300) and other component elements.

The server apparatus 100 is a V2X application server that provides a V2X service for the purpose of improving safety on a road. The server apparatus 100 is connected to a plurality of base stations including base stations 300a and 300b through a network 10. The network 10 may be, for example, a 5G core network or a combination of a 5G core network and an IP network.

The UE 200 is a terminal device that uses the V2X service provided by the server apparatus 100. In the example of FIG. 3, the UE 200a and the UE 200b are pedestrian terminals, and the UE 200c and the UE 200d are in-vehicle terminals. For example, the UE 200a located in a cell 30a is capable of establishing a radio link with the base station 300a, receiving downlink data from base station 300a, and transmitting uplink data to the base station 300a. In addition, the UE 200a is capable of communicating with another V2X UE, which is present in the vicinity, via the sidelink, while receiving support (for example, scheduling of resources or allocation of a resource pool beforehand) from the base station 300a. For example, FIG. 3 illustrates a sidelink 40b between the UE 200a and the UE 200b and a sidelink 40c between the UE 200a and the UE 200c. As a matter of course, any UE 200 other than the UE 200a is also capable of communicating with a V2X UE in the vicinity via a sidelink.

The base station 300 may be, for example, a gNB or an ng-eNB, and relays communication between the UE 200 and the server apparatus 100. In the example of FIG. 3, the base station 300a provides services for the UE 200 in the cell 30a, and the base station 300b provide services for the UE 200 in a cell different from the cell 30a. Information from the base station 300 to the plurality of UEs 200 in the cell is broadcast on a physical broadcast channel (PBCH). The downlink data from the base station 300 to a particular UE 200 is transmitted on a physical downlink shared channel (PDSCH). The uplink data from a particular UE 200 to the base station 300 is transmitted on a physical uplink shared channel (PUSCH). Control signaling (for example, downlink allocation, scheduling request, uplink grant, retransmission control, and the like) for controlling such data transmission is provided on various control channels including a physical downlink control channel (PDCCH) and a physical uplink control channel (PUCCH).

In the present embodiment, the UE 200 is capable of operating in one of a plurality of operation modes including a continuous reception mode and a discontinuous reception (DRX) mode. The operation mode here may be a mode related to all of the downlink, uplink, and sidelink, or may be a mode related to only the sidelink. For example, while operating in the continuous reception mode, the UE 200 monitors all candidate resources of the sidelink, and receives a V2X message that is broadcast, groupcast, or unicast to the UE 200 itself. On the other hand, while operating in the DRX mode, the UE 200 monitors only a candidate resource included in the ON section that periodically arrives in accordance with the DRX cycle, and receives the V2X message transmitted on such a candidate resource. By operating in the DRX mode, the UE 200 is capable of reducing power consumption and extending battery service life.

In addition, in the present embodiment, when at least some UEs 200 generates an urgent message to be notified to another terminal device, they are set to be capable of transmitting such an urgent message via the sidelink. For example, when at least some UEs 200 detect a threat about the safety on the road, or predicts that a threat will occur in the near future, they are set to be capable of transmitting, via the sidelink, an alarm message (an urgent message) that informs of the presence of such a threat. The UE 200 may detect a threat about the safety using any known method. For example, the UE 200, which is mounted in a vehicle, may recognize one or more of the following ones as a threat.
Speed or acceleration of the self-vehicle or another vehicle exceeding a reference value
Deviation of the self-vehicle or another vehicle from a correct driving lane
Physiological abnormality of the driver in the self-vehicle.
Detection of alcohol component from exhaled air of the driver in the self-vehicle
Detection of contact or collision
Abnormal in driving environment (for example, presence of a falling object and a decrease in road surface temperature)

The UE 200, which has detected such a threat about the safety, transmits an alarm message on, for example, a sidelink shared channel (SL-SCH). The alarm message may include type information indicating the type of the threat that has been detected. The server apparatus 100 sets each UE 200 to receive an alarm message transmitted from another UE 200 via the sidelink. The UE 200, which has received the alarm message, issues an alarm to the user via a user interface, so that the user can recognize the threat promptly and take an appropriate action to ensure the safety.

In the same geographical area, however, a scenario is assumed in which the ON section in the DRX cycle is synchronized such that the V2X communication via the sidelink is enabled between a plurality of UEs 200, which are operating in the DRX mode. When the UE 200, which is located in an overlapping area of the plurality of geographical areas, receives the urgent message (for example, a message informing of the presence of a threat about the safety on the road), the UE 200 relays such a message, so that the message of high urgency can be shared with another terminal device in a wider geographical area. However, after receiving the message and waiting for the next DRX cycle, if relay transmission of the message is performed, this may possibly lead to a delay in notification of the message. Therefore, as will be described later, in the V2X communication system 1 according to the present embodiment, a mechanism is incorporated to enable a terminal device that performs a DRX operation to relay a message of high urgency that has been received in a first geographical area to an adjacent second geographical area more promptly.

### Example Configuration of Server Apparatus

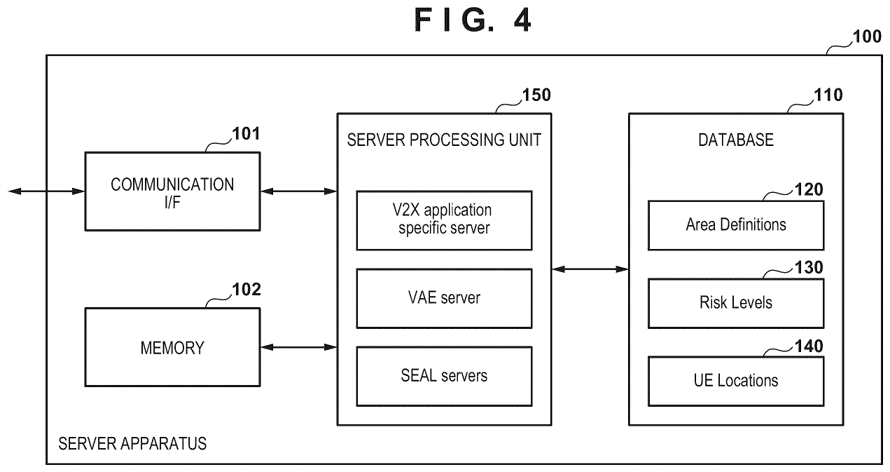

FIG. 4 is a block diagram illustrating a configuration example of the server apparatus 100 according to the present embodiment. Referring to FIG. 4, the server apparatus 100 includes a communication interface (I/F) 101, a memory 102, a database 110, and a server processing unit 150.

The communication I/F 101 is a communication unit for the server apparatus 100 to communicate with one or more UEs 200 each operating as a client of the V2X application. The communication I/F 101 is connected to the network 10, and is capable of communicating with the UE 200, which is in connection with the base station 300, via one or more network nodes in the network 10 and the base station 300.

The memory 102 may include any combination of a nonvolatile storage medium such as a read only memory (ROM) and a volatile storage medium such as a random access memory (RAM). For example, the ROM stores beforehand computer programs for several server modules to be described below. The RAM provides a temporary storage area for processing by the server processing unit 150.

The database 110 is a database that stores various data necessitated for providing the V2X application by the server apparatus 100. In the present embodiment, the database 110 includes area definition data 120, risk level data 130, and UE location data 140. Note that here, an example in which the server apparatus 100 includes the database 110 will be described. However, the database 110 may be implemented in a device (for example, a database server or a cloud server) separate from the server apparatus 100, as long as it is accessible by the server processing unit 150.

The area definition data 120 is data indicating definitions of a plurality of geographical areas for the V2X application provided by the server apparatus 100. The area definition data 120 can include the following three data items, for example, for each geographical area.
“Area ID”
“Area definition”
“Associated base station”
“Adjacent area”

The “area ID” is an identifier for uniquely identifying each geographical area. The “area definition” is an aggregation of parameters that define the geographical location and shape of each geographical area. For example, for a polygonal geographical area, the “area definition” indicates a set of coordinate values (for example, latitude and longitude) of N vertices (where N is an integer equal to or larger than 3). For a circular geographical area, the “area definition” indicates coordinate values of a center point and a radius. The “associated base station” indicates at least one address (or another type of identification information) for communication with a base station that provides services in each geographical area. The “adjacent area” is data indicating an adjacent relationship between geographical areas. For example, in a case where second and third geographical areas are adjacent to a first geographical area, the “adjacent area” in a record of the first geographical area can indicate a list of area IDs of the second and third geographical areas.

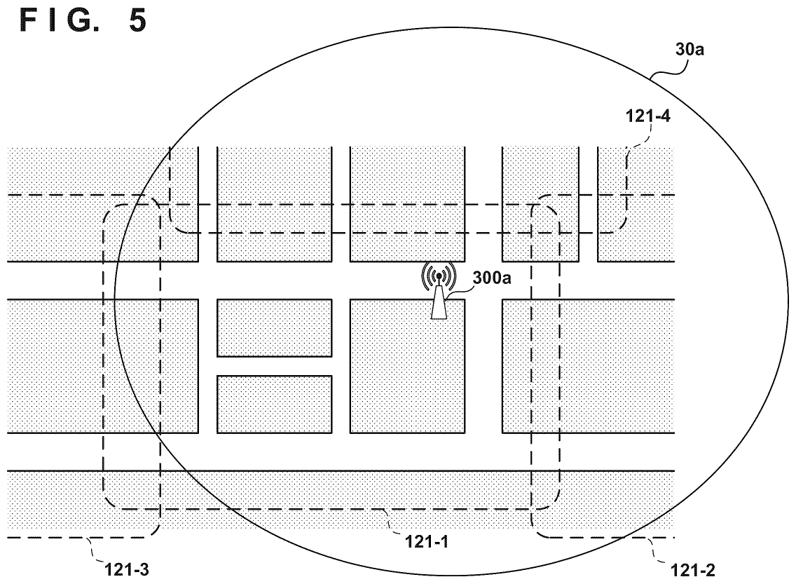

FIG. 5 is an explanatory diagram for describing an example of definitions of geographical areas. Referring to FIG. 5, boundary lines of the four geographical areas 121-1, 121-2, 121-3, and 121-4 are respectively indicated by broken lines in a superimposed manner on a road map of an area where the base station 300a is installed. Here, the shapes of these geographical areas are each substantially rectangular. The geographical areas 121-2, 121-3, and 121-4 are adjacent areas to the geographical area 121-1. Thus, in this case, the area definition data 120 can include a record for associating the “area ID” identifying the geographical area 121-1 with a list of area IDs of the respective geographical areas 121-2, 121-3 and 121-4 as “adjacent areas”. Two adjacent geographical areas may partially overlap with each other. FIG. 5 also illustrates a boundary line of the cell 30a of the base station 300a. The geographical area is typically defined in consideration of the purpose of the V2X application, independently of the coverage of a cell. For example, in the present embodiment, a certain area may be divided into a plurality of geographical areas, based on differences in road characteristic (examples including a speed limit and the number of vehicle lanes) and traffic tendencies (examples including the number of pedestrians, and the frequency of occurrence of traffic congestion).

The risk level data 130 is data indicating a risk level determined for each of a plurality of geographical areas defined by the area definition data 120. The risk level data 130 can include, for example, the following three data items.
“Management area”
“Risk level”
“Last updated”

The “management area” identifies each of the geographical areas, the risk level of which is to be managed, with use of the “area ID” registered in the area definition data 120. The “risk level” is a parameter indicating a risk level determined for a geographical area identified by the “management area”. In the present embodiment, the “risk level” is evaluated in three levels, and indicates any value of “low” meaning that the risk level is the lowest, “medium” meaning that the risk level is medium, and “high” meaning that the risk level is the highest. Note that in another embodiment, the “risk level” may be evaluated in two levels or four or more levels. The “last updated” indicates the date and time when the value of the “risk level” was updated last time for each geographical area.

The UE location data 140 is data for managing the location of the V2X UE, which uses the V2X application provided by the server apparatus 100. The UE location data 140 may include, for example, the following four data items.
“UE ID”
“Location”
“Staying area”
“Last reported”

The “UE ID” is an identifier for uniquely identifying each V2X UE. The “location” indicates the location reported last time from each V2X UE. The “staying area” identifies a geographical area corresponding to the location reported last time from each V2X UE with use of the “area ID” registered in the area definition data 120. The “last reported” indicates the date and time when the location was reported last time from each V2X UE.

Note that the configuration of the database 110 is not limited to the configuration described here. The database 110 may store additional data, and some data items described above may be omitted. For example, the database 110 may store a user ID and authentication information (for example, a password, an authentication key, or the like) for authenticating a user who uses the V2X application provided by the server apparatus 100.

The server processing unit 150 is a functional module that operates as a server of the V2X application. The function of the server processing unit 150 can be achieved by one or more processors (for example, a central processing unit (CPU)) executing a computer program stored in the memory 102. As illustrated in FIG. 4, the server processing unit 150 includes three server modules of the V2X application specific server, the VAE server, and the SEAL server. The functions shared by these server modules may be as described with reference to FIG. 2.

When the UE 200 operating as a client of the V2X application is connected to the base station 300, the server processing unit 150 performs an authentication procedure as necessary, and then sets up a communication link (V1-APP/V1-AE/SEAL-UU) for V2X communication with the UE 200.

In addition, the server processing unit 150 sets the UE 200 to receive an alarm message transmitted from another V2X UE via the sidelink. For example, when the alarm message is broadcast on the PC5 interface, the server processing unit 150 sets the UE 200 to monitor a message having a layer-2 ID of a destination for broadcast reception on a sidelink resource. When the alarm message is groupcast on the PC5 interface, the server processing unit 150 assigns a group ID for alarm message reception to the UE 200, and sets the UE 200 to monitor a message having the layer-2 ID of the destination corresponding to the group ID on the sidelink resource. The alarm message may be transmitted by unicast. However, in light of prompt transmission of the alarm message, broadcast or groupcast is more advantageous than unicast that necessitates the establishment of an individual PC5 interface.

Further, the server processing unit 150 manages the risk level of each geographical area indicated by the risk level data 130. For example, the initial value of the “risk level” of the risk level data 130 is determined beforehand, based on static characteristics of a road in a corresponding geographical area, such as a speed limit, the number of vehicle lanes, a curvature, separation between a roadway and a sidewalk, and presence of a step. The server processing unit 150 may update the value of the “risk level”, based on a temporal condition or a sunlight condition that can include a season or a time zone (for example, the risk level may be increased by one level in the evening when the visibility degrades). Furthermore, in the present embodiment, the server processing unit 150 updates the value of the “risk level” of the risk level data 130, based on the V2X message received from one or more terminal devices via the communication I/F 101. Each of the terminal devices here may be the UE 200, which has been described with reference to FIG. 3, or may be another type of terminal device (for example, a roadside unit including a sensor or a camera). For example, in a case where it is determined that a following event has occurred in a certain geographical area, based on the V2X message received from the terminal device, the server processing unit 150 may temporarily increase the value of the “risk level” of the geographical area until it is determined that the event has been eliminated.
Presence of a vehicle that satisfies the above-described threat detection condition
Vehicle that is stopped on a road
Traffic jam
Abnormality in driving environment

The server processing unit 150 also tracks the location of the UE 200 in connection. Specifically, the server processing unit 150 periodically receives the location information of the UE 200 via the communication I/F 101 from the UE 200 in connection. Then, the server processing unit 150 determines in which geographical area the UE 200 is located, based on the received location information, and updates the “location”, “staying area”, and “last reported” of the corresponding record in the UE location data 140. The location information may indicate location coordinates of a geographical location obtained as a result of positioning in the UE 200, as the location of the UE 200. In this case, the server processing unit 150 is capable of determining to which geographical area the geographical position indicated by the location information belongs, based on the “area definition” of the area definition data 120. In a case where the size of the geographical area is equal to or larger than the size of the cell serviced by the base station 300, the location information may indicate the cell ID of the cell that is a connection destination of the UE 200, as the location. In this case, the server processing unit 150 is capable of determining to which geographical area the cell of the connection destination of the UE 200 belongs, based on known mapping between the cell ID indicated by the location information and the area ID of the corresponding geographical area.

### Configuration Example of Terminal Device

FIG. 6 is a block diagram illustrating a configuration example of the UE 200 according to the present embodiment. Referring to FIG. 6, the UE 200 includes a radio I/F 201, a memory 202, a storage 203, a sensor group 204, a camera 205, a positioning module 206, an input device 207, an output device 208, a power supply 209, and a control unit 210.

The radio I/F 201 is a radio communication unit for the UE 200 to perform radio communication. In the present embodiment, the radio I/F 201 is capable of communicating via a radio link established with the base station 300, and is further capable of communicating via a sidelink with another V2X UE. In addition, the radio I/F 201 is capable of operating in one of a plurality of operation modes including a continuous reception mode and a discontinuous reception (DRX) mode.

The memory 202 may include any combination of a nonvolatile storage medium such as a ROM and a volatile storage medium such as a RAM. For example, the ROM stores beforehand computer programs for several client modules that operate in the control unit 210. The RAM provides a temporary storage area for processing by the control unit 210.

The storage 203 is a storage device for storing large-scale data. The storage 203 may be, for example, a hard disk drive (HDD) or a solid state drive (SSD).

The sensor group 204 is an aggregation of various sensors mounted on the UE 200. In a case where the UE 200 is a pedestrian terminal, the sensor group 204 can include an acceleration sensor, a gyro sensor, and an azimuth sensor. In a case where the UE 200 is an in-vehicle terminal, the sensor group 204 can further include sensors such as a distance measuring sensor (for example, a LiDAR or a millimeter wave radar) and a biological information sensor, in addition to the above-described sensors.

The camera 205 is an imaging module capable of imaging a situation in the surroundings of the UE 200. The sensor group 204 and the camera 205 may be used to detect a threat about the safety on a road in accordance with the above-described threat detection condition.

The positioning module 206 is a module for measuring the position of the UE 200. The positioning module 206 may be capable of acquiring the latitude, longitude, and altitude of the current position of the UE 200, by using, for example, a global navigation satellite system (GNSS) represented by a global positioning system (GPS). Alternatively or additionally, the positioning module 206 may be capable of estimating the current position of the UE 200, based on the known absolute position of the base station that is a connection destination and the relative position from the base station.

The input device 207 is a device for the UE 200 to receive an instruction and information input from the user. The input device 207 includes one or more of, for example, a touch sensor, a button, a switch, a keypad, and a microphone.

The output device 208 is a device for the UE 200 to output information or a signal to the user. The output device 208 includes one or more of, for example, a display, a speaker, a light, and a vibrator.

The power supply 209 is a rechargeable battery for supplying electric power to each unit of the UE 200 via an electric power line partially illustrated in the drawing. The supply of the electric power from the power supply 209 is controlled by the control unit 210. For example, while the radio I/F 201 is operating in the DRX mode, the electric power supplied from the power supply 209 to the radio I/F 201 is reduced in an OFF section that periodically arrives.

The control unit 210 includes one or more processors, and controls the overall functions of the UE 200, by executing a computer program stored in the memory 202. For example, the control unit 210 functions as a client processing unit 220, which operates as a client of the V2X application. The client processing unit 220 includes three client modules including the V2X application specific client, the VAE client, and the SEAL client. The functions shared among these client modules may be as described with reference to FIG. 2. The control unit 210 may also have various other functions of a general pedestrian terminal or in-vehicle terminal. However, here, in order to simplify the description, the functions of the client processing unit 220 will be mainly described

The client processing unit 220 is set by the server processing unit 150 of the server apparatus 100 to receive an alarm message about the safety on a road transmitted from another V2X UE via the sidelink. Upon receipt of the alarm message via the sidelink, the client processing unit 220 issues an alarm to the user via the user interface of the UE 200 so that the user can take an appropriate action to ensure the safety. For example, the alarm may be issued by displaying an alarm text or an icon on the display of the output device 208, outputting an alarm sound or a sound for alarm from the speaker, or vibrations of the vibrator.

The client processing unit 220 may be capable of detecting a threat about the safety in accordance with one or more of the above-described threat detection conditions, based on sensor data input from the sensor group 204 or video data input from the camera 205. Upon detection of the threat about the safety, the client processing unit 220 issues an alarm to the user, and also causes the radio I/F 201 to give an alarm message on a sidelink communication resource. As described above, the alarm message can be emitted in any of broadcast, groupcast, or unicast. Note that the client processing units 220 of all the UEs 200 do not necessarily have the function of transmitting the alarm message.

The client processing unit 220 periodically reports the server apparatus 100 on the location information indicating the latest location of the UE 200 acquired by the positioning module 206. The V2X message for reporting the location information is transmitted to the server apparatus 100 via the radio I/F 201 and the base station 300, which is a connection destination. As described above, the server processing unit 150 of the server apparatus 100 determines in which geographical area the UE 200 is located in accordance with the report of such location information.

The V2X message transmitted to the server apparatus 100 may include information for updating the risk level for every geographical area managed by the server processing unit 150. For example, the client processing unit 220 may transmit sensor data input from the sensor group 204 to the server apparatus 100. In addition, the client processing unit 220 may notify the server apparatus 100 that the threat about the safety has been detected in accordance with any of the threat detection conditions. Further, the client processing unit 220 may perform more advanced processing such as determination of a stopped vehicle, determination of traffic congestion, or determination of an abnormality in driving environment, and may notify the server apparatus 100 of a determination result.

In the present embodiment, the client processing unit 220 receives a control message from the server apparatus 100 via the radio I/F 201 as a response to the transmission of the location information. The control message may include an area ID identifying a geographical area in which it is determined that the UE 200 is located, from among a plurality of predefined geographical areas for the V2X application.

### Configuration Example of Base Station

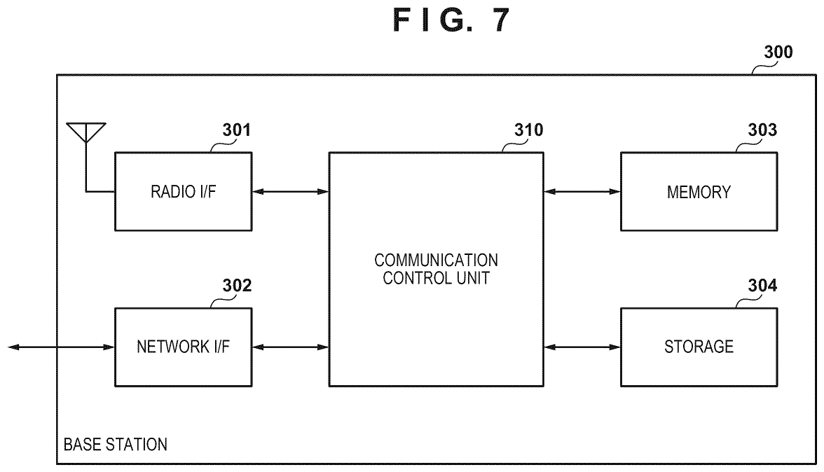

FIG. 7 is a block diagram illustrating a configuration example of the base station 300 according to the present embodiment. Referring to FIG. 7, the base station 300 includes a radio I/F 301, a network I/F 302, a memory 303, a storage 304, and a communication control unit 310.

The radio I/F 301 is a radio communication unit for the base station 300 to provide radio access for one or more UEs 200 in a cell 30. For example, in a case where the coverage of the cell 30 of the base station 300 includes a first geographical area, the base station 300 may perform radio communication with the UE 200, which is located in at least the first geographical area, via the radio I/F 301.

The network I/F 302 is a network communication unit for the base station 300 to communicate with a network node in the network 10 and another device connected to the network 10. The base station 300 is capable of communicating with the server apparatus 100 via the network I/F 302, for example.

The memory 303 may include any combination of a nonvolatile storage medium such as a ROM and a volatile storage medium such as a RAM. For example, the ROM stores beforehand a computer program to be executed by the communication control unit 310. The RAM provides a temporary storage area for processing by the communication control unit 310. The storage 304 is a storage device for storing large-scale data. The storage 304 may be, for example, an HDD or an SSD.

The communication control unit 310 includes one or more processors, and executes a computer program stored in the memory 303 to control radio communication performed by the radio I/F 301 and network communication performed by the network I/F 302. For example, when a connection request from the UE 200 is received by the radio I/F 301, the communication control unit 310 establishes a radio link between the UE 200 and the radio I/F 301. In addition, when the UE 200 uses the V2X application provided by the server apparatus 100, the communication control unit 310 mediates communication at an application level between the UE 200 and the server apparatus 100. Furthermore, the communication control unit 310 schedules a resource of the sidelink, or allocates a resource pool for the sidelink for the UE 200, which is the V2X UE. Accordingly, the UE 200 is capable of performing radio communication with the base station 300 via the radio link and with another V2X UE via the sidelink.

### Relay Processing of Urgent Message

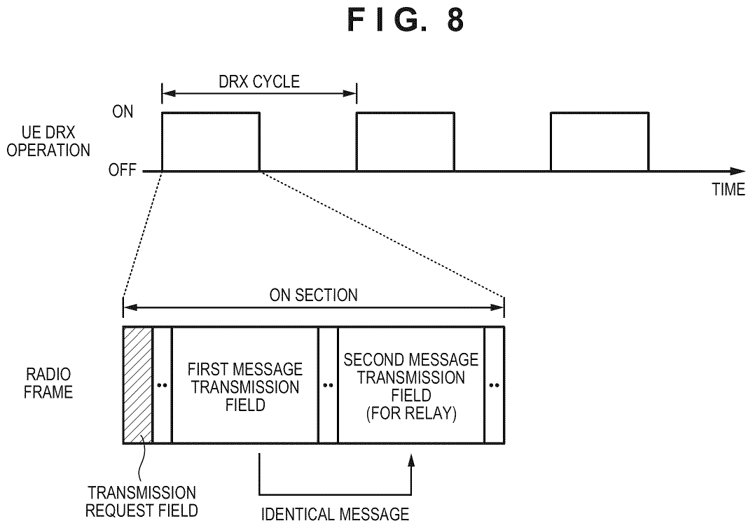

Next, an example of relay processing of an urgent message performed by the UE 200 according to one embodiment will be described with reference to FIG. 8. Here, a scenario is assumed in which an ON section in the DRX cycle is synchronized so that V2X communication via the sidelink is enabled between a plurality of UEs 200, which are operating in the DRX mode in the same geographical area. In the DRX mode, an ON section and an OFF section are alternately and periodically repeated with the DRX cycle including the ON section and the OFF section as one cycle. The UE 200, which is operating in the DRX mode, monitors only a candidate resource included in the ON section that periodically arrives in accordance with the DRX cycle, and receives the V2X message transmitted on the candidate resource. In addition, when a message to be transmitted is generated, the UE 200 transmits the message using the sidelink communication resource in the ON section in the DRX cycle.

FIG. 8 illustrates an example of a transmission frame (a radio frame) transmitted and received between the UEs 200 via the sidelink in the ON section in the DRX cycle. Note that in the present example, the length of the transmission frame matches the length of the ON section in the DRX cycle. However, the length of the transmission frame may be different from the length of the ON section in the DRX cycle (for example, may be shorter than the length of the ON section). In addition, the transmission frame used in the ON section in the DRX cycle may be configured as a subframe that is a part of the radio frame.

As illustrated in FIG. 8, a transmission frame section corresponding to the ON section in the DRX cycle includes at least “a transmission request field”, “a first message transmission field”, and “a second message transmission field”. Between the transmission request field and the first message transmission field, one or more other fields or a transmission gap may be provided, or the transmission request field and the first message transmission field may be continuously arranged. Further, between the first message transmission field and the second message transmission field, one or more other fields or a transmission gap may be provided, or the first message transmission field and the second message transmission field may be continuously arranged.

In the present example, it is assumed that the UE 200 is located in the vicinity of the boundary of the adjacent geographical areas A and B, and is located in an overlapping area of the geographical areas A and B. In this case, upon receipt of an urgent message transmitted from another UE, which is located in the geographical area A, via the sidelink, the UE 200 transmits the urgent message via the sidelink to relay it to another UE, which is located in the geographical area B.

By using the first message transmission field illustrated in FIG. 8, the UE 200 receives the urgent message transmitted from another UE, which is located in the geographical area A. In addition, by using the second message transmission field illustrated in FIG. 8, the UE 200 transmits the message identical to the received urgent message to relay it to another UE, which is located in the geographical area B. In this manner, in the present embodiment, in addition to the first message transmission field that can be used to transmit the urgent message, the second message transmission field that can be used to relay the received urgent message is further provided in the transmission frame corresponding to the ON section in the DRX cycle.

The transmission request field is provided in a head part of a transmission frame section corresponding to the ON section in the DRX cycle, and is used for a transmission request of an urgent message. The transmission request field is used for the UE 200 to transmit a transmission request for transmitting an urgent message to another UE within the identical DRX cycle to another UE via the sidelink. The transmission of the transmission request enables a notification to another UE that the message transmission field included in the identical DRX cycle is preferentially used for transmitting the urgent message. In the ON section in the DRX cycle, another UE, which has received the transmission request using the transmission request field from the UE 200, operates refraining from using the message transmission field included in the identical DRX cycle. Accordingly, it becomes possible to avoid a collision in the message transmission field between the transmission of the urgent message from the UE 200 and the transmission of a normal message from another UE. Note that it is not possible to avoid a collision in the message transmission field between the transmission of the urgent message from the UE 200 and the transmission of the urgent message from another UE. However, the probability of an occurrence of such a collision will be very low.

When transmitting an urgent message, the UE 200 first transmits a transmission request to another UE via the sidelink by using the transmission request field. In this case, information indicating the transmission request is stored in the transmission request field. As the information indicating the transmission request, for example, identification information of the UE 200 is stored in the transmission request field. The identification information of the UE 200 may be information indicating an address (for example, a layer-2 ID) allocated to the UE.

The first message transmission field can be used for transmission of an urgent message or transmission of a normal message other than the urgent message. After transmitting the transmission request using the transmission request field, the UE 200 transmits the urgent message to another UE via the sidelink, by using the first message transmission field in the identical DRX cycle. In this manner, it becomes possible to transmit the urgent message in the DRX cycle identical to the DRX cycle in which the transmission request has been transmitted. Accordingly, it becomes possible to promptly notify another UE located in the same geographical area with the UE 200 of the urgent message via the sidelink.

In addition, in response to receipt of the transmission request in the transmission request field from another UE, which is located in the geographical area A, the UE 200 receives the urgent message from such another UE by using the first message transmission field in the transmission frame section corresponding to the ON section in the identical DRX cycle. Upon receipt of the urgent message, the UE 200 transmits the urgent message that has been received to relay it to another UE located in the geographical area B, which is adjacent to the geographical area A, by using the second message transmission field (the second message transmission field in a transmission frame section corresponding to the ON section in the identical DRX cycle to the first message transmission field) subsequent to the first message transmission field.

Transmission of the transmission request using the transmission request field and transmission and relay of an urgent message using the first and second message transmission fields are performed by broadcast or groupcast using a sidelink communication resource. Note that the communication resource of the control area in the radio frame (or the subframe) may be used for the transmission request field, and the communication resource of the data area in the radio frame (or the subframe) may be used for the first and second message transmission fields.

### Flow of Processing

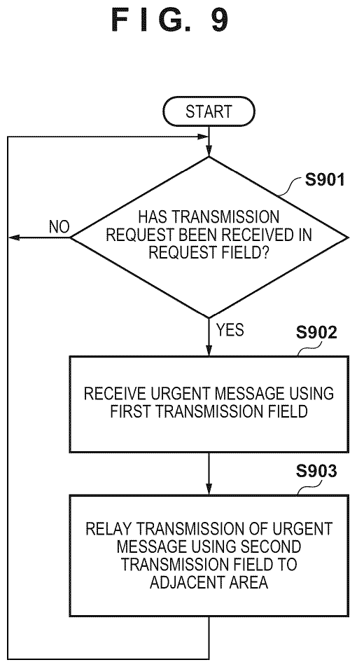

FIG. 9 is a flowchart illustrating an example of a processing procedure by the UE 200 in the V2X communication system 1 according to one embodiment. The UE 200 performs processing in accordance with the procedure of FIG. 9 while operating in the DRX mode. It is assumed that the UE 200 is located in the vicinity of the boundary between the geographical areas A and B, and in the geographical area A, a setting for relaying the urgent message to the geographical area B is made by the server apparatus 100 of the V2X application. The UE 200 relays the urgent message in accordance with such a setting for the geographical area A.

In S901, the UE 200 determines whether the transmission request of the urgent message is received from another UE via the sidelink in the transmission request field in the head part of the corresponding transmission frame section in the ON section in the DRX cycle. When the UE 200 receives the request for transmitting the urgent message, the processing proceeds to S902, and when the request for transmitting the urgent message is not received, the determination in S901 is repeated. Here, it is assumed that a transmission request from the UE in the geographical area A is received.

In S902, the UE 200 receives the urgent message transmitted from the UE, which is a transmission source of the transmission request, by using the first message transmission field included in the transmission frame section corresponding to the ON section in the identical DRX cycle to the transmission request field. Then, in S903, the UE 200 relays the received urgent message to the UE, which is located in the geographical area B adjacent to the geographical area A, by using the second message transmission field in the transmission frame section corresponding to the ON section in the identical DRX cycle. That is, the UE 200 copies the urgent message stored in the first message transmission field into the second message transmission field, and transmits the urgent message. Then, the UE 200 returns the processing to S901.

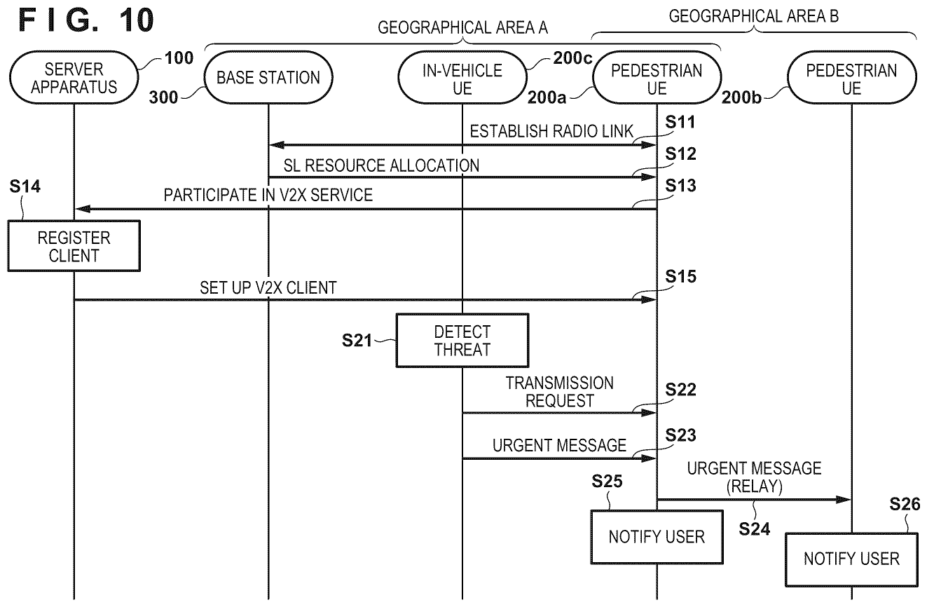

FIG. 10 is a sequence diagram illustrating an example of a flow of processing in the V2X communication system 1 according to one embodiment. In the illustrated processing, the server apparatus 100, the UEs 200a, 200b, and 200c, and the base station 300 are involved. As illustrated in FIG. 3, the UE 200a and the UE 200b are each a pedestrian terminal (pedestrian UE), and UE 200c is an in-vehicle terminal (in-vehicle UE). In the present example, the server apparatus 100 (the server processing unit 150) operates as a server of the V2X application, and the UEs 200a, 200b, and 200c operate as clients (V2X UEs) of the V2X application. The UEs 200a, 200b, and 200c are all operating in the DRX mode.

First, in S11, the UE 200a establishes a radio link with the base station 300, when entering the cell 30a, which is serviced by the base station 300. When the radio link between the UE 200a and the base station 300 is established, the base station 300 (the communication control unit 310) schedules the resource of the sidelink, or allocates the resource pool of the sidelink for the UE 200a, which is the V2X UE, in S12.

Next, in S13, the UE 200a (the client processing unit 220) accesses the server apparatus 100 using the URL of the server apparatus 100 stored beforehand in the memory 202, for example, and participates in the V2X service provided by the server apparatus 100. In S14, the server apparatus 100 (the server processing unit 150) registers the UE 200a as a client in connection (when the authentication of the UE 200a is successful). Furthermore, in S15, the server apparatus 100 sets up a communication link with the UE 200a. For example, the UE 200a sets up the radio I/F 201 to receive an alarm message (an urgent message) transmitted from another V2X UE via the sidelink in accordance with the setting made by the server apparatus 100.

Here, the UE 200a and the UE 200c are located in the cell 30a of the base station 300. In addition, the UE 200a and the UE 200c are located in the identical geographical area A, which is managed by the server apparatus 100, and participate in the same V2X service. Further, the UE 200b is located in the geographical area B, which is managed by the server apparatus 100, and participates in the same V2X service. The UE 200a is located in an area overlapping with the adjacent geographical area B in the vicinity of the boundary of the geographical area A. The UEs 200a, 200b, and 200c are capable of performing the V2X communication with another UE in the identical geographical area via the sidelink and the V2X communication with the server apparatus 100. In addition, in the geographical areas A and B in which the UEs 200a, 200b, and 200c are located, the base station 300 controls the ON sections in the DRX cycles to be synchronized among the UEs in the geographical areas. Therefore, the UEs (in the present example, the UEs 200a, 200b, and 200c) operating in the DRX mode in the geographical areas A and B are respectively capable of performing the V2X communication with another UE via the sidelink in the ON sections in the DRX cycles.

In the following, description will be given with regard to an example in which the UE 200c, which is an in-vehicle terminal, broadcasts an urgent message in response to detection of a threat about the safety on a road in the geographical area A, and the UE 200a relays the urgent message that has been received to another UE (the UE 200b) in the geographical area B.

In S21, it is assumed that the UE 200c, which is an in-vehicle terminal, detects a threat about the safety on a road. The UE 200c performs transmission processing of transmitting an urgent message to another UE via the sidelink in response to the detection of the threat about the safety on the road.

Specifically, in S22, when the ON section in the DRX cycle arrives, the UE 200c transmits the transmission request using the transmission request field provided in the head part in the transmission frame (the radio frame) section corresponding to the ON section. The transmission request is transmitted to request transmission of an urgent message to another UE (V2X UE) via the sidelink in the identical DRX cycle. After transmitting the transmission request, the UE 200c transmits (for example, broadcasts or groupcasts) the urgent message on the sidelink communication resource in S23, by using the first message transmission field in the transmission frame (the radio frame) section in the identical DRX cycle.

When the UE 200a receives the transmission request of the urgent message from the UE 200c in the transmission request field in the head part of the corresponding transmission frame in the ON section in the DRX cycle, the UE 200a operates preferentially using a subsequent first message transmission field by the UE 200c. That is, even though transmission data to be transmitted via the sidelink is generated, the UE 200a does not transmit the transmission data in the ON section in the DRX cycle in which the transmission request has been received, and postpones the transmission to the next or subsequent DRX cycle. In the DRX cycle in which the transmission request has been received, the UE 200a receives the urgent message transmitted from the UE 200c in the first message transmission field subsequent to the transmission request field.

Upon receipt of the urgent message, the UE 200a performs relay transmission of the received urgent message in S24, by using the second message transmission field in the transmission frame section corresponding to the ON section in the identical DRX cycle to the first message transmission field. Specifically, by using the second message transmission field, the UE 200a transmits (for example, broadcasts or groupcasts) the urgent message on the sidelink communication resource to relay the urgent message to the UE (the UE 200b) in the geographical area B. The UE 200a transmits (relays) the urgent message, and notifies the user via the user interface in S25, based on the urgent information included in the urgent message. The urgent message includes, as the urgent information, information indicating detection of the threat about the safety on the road by the UE 200c. The notification to the user prompts the user to take an appropriate action to ensure the safety.

Upon receipt of the urgent message that has been relayed, the UE 200b notifies the user via the user interface in S26, based on the urgent information included in the urgent message. The urgent message includes, as the urgent information, information indicating detection of the threat about the safety on the road by the UE 200c. The notification to the user prompts the user to take an appropriate action to ensure the safety.

As described heretofore, the UE 200 (the terminal device) in the present embodiment is operable in the DRX mode, and includes the radio I/F 201, which performs radio communication via the radio link between the UE 200 and the base station 300 and via the sidelink between the UE 200 and another UE, and the control unit 210, which controls radio communication by the radio I/F 201. The control unit 210 receives, via the sidelink, the urgent message transmitted from the terminal device located in the first geographical area, by using the first message transmission field in the transmission frame section corresponding to the ON section in the DRX cycle. The control unit 210 transmits the received urgent message via the sidelink to relay it to a terminal device located in the second geographical area adjacent to the first geographical area, by using the second message transmission field in the transmission frame section corresponding to the ON section in the identical DRX cycle to the first message transmission field. In this manner, the control unit 210 is capable of achieving the relay transmission in a short time from the reception of the urgent message, by relaying the urgent message that has been received in the first message transmission field, in the second message transmission field included in the identical DRX cycle. Therefore, according to the present embodiment, in the terminal device that performs the DRX operation, it becomes possible to relay a message of high urgency received in the first geographical area to the adjacent second geographical area more promptly.

### Summary of Embodiments

The above embodiments disclose at least the following terminal device and communication control method.

### Item 1

A terminal device (200) comprising:
a radio communication unit (201) capable of operating in a discontinuous reception (DRX) mode, and configured to perform radio communication via a radio link between the terminal device and a base station and radio communication via a sidelink between the terminal device and another terminal device; and
a control unit (210) configured to control the radio communication by the radio communication unit,
wherein the control unit (210) is configured to:
   receive, via the sidelink, an urgent message transmitted by a terminal device located in a first geographical area, by using a first transmission field in a transmission frame section corresponding to an ON section in a DRX cycle; and
   transmit, via the sidelink, the received urgent message so as to relay that urgent message to a terminal device located in a second geographical area adjacent to the first geographical area, by using a second transmission field in the transmission frame section corresponding to the ON section in an identical DRX cycle to the first transmission field.

According to this item, it becomes possible to, in a terminal device that performs a DRX operation, relay a message of high urgency received in a first geographical area to an adjacent second geographical area more promptly.

### Item 2

The terminal device according to Item 1, wherein the control unit (210) is configured to, upon receipt of a transmission request from the terminal device located in the first geographical area in a request field for requesting transmission of the urgent message, the request field being provided in a head part of the transmission frame section corresponding to the ON section in the DRX cycle, receive the urgent message from the terminal device by using the first transmission field, and transmit the received urgent message by using the second transmission field.

According to this item, it becomes possible to appropriately relay the urgent message while avoiding a collision between reception of the urgent message and transmission of the transmission data.

### Item 3

The terminal device according to Item 2, wherein the request field is included in the transmission frame section corresponding to the ON section in the identical DRX cycle to the first and second transmission fields.

According to this item, it becomes possible to relay the urgent message more promptly while avoiding the collision between the reception of the urgent message and the transmission of the transmission data in the identical DRX cycle.

### Item 4

The terminal device according to Item 2 or 3, wherein identification information of a terminal device that is a transmission source of the transmission request is stored in the request field, as information indicating the transmission request.

According to this item, the urgent message transmission request is enabled using the identification information of the terminal device.

### Item 5

The terminal device according to Item 4, wherein the identification information includes address information indicating an address allocated to the terminal device that is the transmission source of the transmission request.

According to this item, the urgent message transmission request is enabled using the address allocated to the terminal device.

### Item 6

The terminal device according to any one of Items 1 to 5, wherein the second transmission field is arranged to be continuous with the first transmission field in the transmission frame section.

According to this item, the first and second transmission fields are continuously arranged, so that the urgent message that has been received in the first transmission field can be relayed in the second transmission field in a shorter time.

### Item 7

The terminal device according to any one of Items 1 to 6, wherein
the first geographical area is an area in which a setting for relaying the urgent message to the second geographical area is made by a server apparatus, of a V2X application, with which the terminal device can communicate via the base station, and
the control unit (210) is configured to transmit, in accordance with the setting made by the server apparatus, the urgent message that has been received using the first transmission field in the transmission frame section, by using the second transmission field so as to relay the urgent message to the second geographical area.

According to this item, it becomes possible to appropriately relay the urgent message in the geographical area that has been set by the server apparatus.

### Item 8

The terminal device according to any one of Items 1 to 7, wherein the urgent message is transmitted in response to detection of a threat concerning safety on a road by the terminal device located in the first geographical area, and includes information indicating the detection of the threat.

According to this item, a detection result of a threat about the safety on a road can be promptly transmitted to another terminal device as an urgent message.

### Item 9

The terminal device according to any one of Items 1 to 8, wherein the control unit (210) is configured to notify, via a user interface, a user of information included in the urgent message together with transmission of the urgent message by using the second transmission field.

According to this item, it becomes possible to prompt the user to appropriately handle a situation of high urgency, based on the information included in the urgent message.

### Item 10

A communication control method performed by a terminal device (200) which is capable of operating in a discontinuous reception (DRX) mode, and is configured to perform radio communication via a radio link between the terminal device (200) and a base station (300) and radio communication via a sidelink between the terminal device (200) and another terminal device, the communication control method comprising:
receiving (S902, S23), via the sidelink, an urgent message transmitted by a terminal device located in a first geographical area, by using a first transmission field in a transmission frame section corresponding to an ON section in a DRX cycle; and
transmitting (S903, S24), via the sidelink, the received urgent message so as to relay that urgent message to a terminal device located in a second geographical area adjacent to the first geographical area, by using a second transmission field in the transmission frame section corresponding to the ON section in an identical DRX cycle to the first transmission field.

According to this item, it becomes possible to, in a terminal device that performs a DRX operation, relay a message of high urgency received in a first geographical area to an adjacent second geographical area more promptly.

The invention is not limited to the foregoing embodiments, and various variations/changes are possible within the spirit of the invention.

What is claimed is:

1. A terminal device comprising:
a radio communication unit capable of operating in a discontinuous reception (DRX) mode, and configured to perform radio communication via a radio link between the terminal device and a base station and radio communication via a sidelink between the terminal device and another terminal device; and
a control unit configured to control the radio communication by the radio communication unit,
wherein the control unit is configured to:
receive, via the sidelink, an urgent message transmitted by a terminal device located in a first geographical area, by using a first transmission field in a transmission frame section corresponding to an ON section in a DRX cycle; and
transmit, via the sidelink, the received urgent message so as to relay that urgent message to a terminal device located in a second geographical area adjacent to the first geographical area, by using a second transmission field in the transmission frame section corresponding to the ON section in an identical DRX cycle to the first transmission field.

2. The terminal device according to claim 1, wherein the control unit is configured to, upon receipt of a transmission request from the terminal device located in the first geographical area in a request field for requesting transmission of the urgent message, the request field being provided in a head part of the transmission frame section corresponding to the ON section in the DRX cycle, receive the urgent message from the terminal device by using the first transmission field, and transmit the received urgent message by using the second transmission field.

3. The terminal device according to claim 2, wherein the request field is included in the transmission frame section corresponding to the ON section in the identical DRX cycle to the first and second transmission fields.

4. The terminal device according to claim 2, wherein identification information of a terminal device that is a transmission source of the transmission request is stored in the request field, as information indicating the transmission request.

5. The terminal device according to claim 4, wherein the identification information includes address information indicating an address allocated to the terminal device that is the transmission source of the transmission request.

6. The terminal device according to claim 1, wherein the second transmission field is arranged to be continuous with the first transmission field in the transmission frame section.

7. The terminal device according to claim 1, wherein
the first geographical area is an area in which a setting for relaying the urgent message to the second geographical area is made by a server apparatus, of a V2X application, with which the terminal device can communicate via the base station, and
the control unit is configured to transmit, in accordance with the setting made by the server apparatus, the urgent message that has been received using the first transmission field in the transmission frame section, by using the second transmission field so as to relay the urgent message to the second geographical area.

8. The terminal device according to claim 1, wherein the urgent message is transmitted in response to detection of a threat concerning safety on a road by the terminal device located in the first geographical area, and includes information indicating the detection of the threat.

9. The terminal device according to claim 1, wherein the control unit is configured to notify, via a user interface, a user of information included in the urgent message together with transmission of the urgent message by using the second transmission field.

10. A communication control method performed by a terminal device which is capable of operating in a discontinuous reception (DRX) mode, and is configured to perform radio communication via a radio link between the terminal device and a base station and radio communication via a sidelink between the terminal device and another terminal device, the communication control method comprising:
receiving, via the sidelink, an urgent message transmitted by a terminal device located in a first geographical area, by using a first transmission field in a transmission frame section corresponding to an ON section in a DRX cycle; and
transmitting, via the sidelink, the received urgent message so as to relay that urgent message to a terminal device located in a second geographical area adjacent to the first geographical area, by using a second transmission field in the transmission frame section corresponding to the ON section in an identical DRX cycle to the first transmission field.
